(19) United States
(12) Patent Application Publication
(10) Pub. No.: US 2013/0207769 A1
(43) Pub. Date: Aug. 15, 2013

(54) Fuse Arrangement

(71) Applicant: Siemens Aktiengesellschaft, (US)

(72) Inventors: Markus Faltermeier, Regensburg (DE); Robert Huttinger, Schofweg (DE); Thomas Lohr, Sinzing (DE); Adolf Schmid, Laaber (DE)

(73) Assignee: SIEMENS AKTIENGESELLSCHAFT, Munchen (DE)

(21) Appl. No.: 13/763,802

(22) Filed: Feb. 11, 2013

(30) Foreign Application Priority Data
Feb. 10, 2012 (DE) 10 2012 202 059.4

(51) Int. Cl. H01H 85/24

(52) U.S. Cl. CPC H01H 85/24
USPC 337/290

(57) ABSTRACT

A fuse arrangement includes a first safety fuse and a second safety fuse connected electrically in parallel with each other. The fuse arrangement also includes an end plate mechanically coupled to the first and second safety fuses to form a structural unit. The creation of a structural unit may actively prevent a disassembly and thus replacement of only one of the two safety fuses. Furthermore, the electrical parallel connection of the two safety fuses may double the maximum current strength of the fuse arrangement and/or significantly reduce the required installation space of the fuse arrangement, with a continuous maximum current strength.

### CROSS-REFERENCE TO RELATED APPLICATIONS

This application claims priority to DE Patent Application No. 10 2012 202 059.4 filed Feb. 10, 2012. The contents of which is incorporated herein by reference in its entirety.

### TECHNICAL FIELD

The disclosure relates to a fuse arrangement for safety fuses.

### BACKGROUND

A safety fuse is an overcurrent protection facility, which interrupts the current circuit by fusing one or more fuse elements if the current strength exceeds a specific value over a specific period of time. It typically consists of an insulated body comprising two electrical connections, which are connected to one another inside the insulating body by way of the fuse element. The fuse element is heated and fused by the current flowing therethrough when the significant nominal current of the fuse is clearly exceeded for a specific period of time.

Safety fuses of this type are used inter alia in the field of electrical installation in so-called electrical installation distributors. Since the installation space in an electrical installation distributor is in most instances limited, with existing electrical installations the electrical line to be fused is divided into several lines which are electrically connected in parallel with one another, and which are fused in each instance with their own safety fuse. Here the maximum current strength is reduced accordingly depending on the safety fuse so that narrower and flatter fuse bodies can be used. As compact an arrangement as possible can be realized in this way. Furthermore, the power loss and the I²t value are reduced by the parallel connection of the safety fuses.

This is nevertheless problematical in that in the event of a change in fuse, the safety fuses can be individually disconnected from an assembly of lines connected electrically parallel to one another and can be exchanged. It may occur that a damaged safety fuse is replaced, but the other, possible already damaged safety fuses remain in the assembly. Furthermore, a safety fuse could be removed from the assembly and replaced by a safety fuse of a different type (with a correspondingly similar installation size). These possibilities are to be prevented under all circumstances against the background of more stringent approval procedures.

### SUMMARY

On embodiment provides a fuse arrangement comprising: a first safety fuse, a second safety fuse, which is arranged adjacent to the first safety fuse and is provided with the first safety fuse for an electrical parallel connection, and an end plate, which is mechanically coupled to the first safety fuse and the second safety fuse, such that a structural unit is herewith formed.

In a further embodiment, the fuse arrangement comprises at least one further safety fuse, which is electrically connected in parallel to the first safety fuse and the second safety fuse and is likewise mechanically coupled to the end plate.

In a further embodiment, the safety fuses each comprise a first contact and a second contact respectively.

In a further embodiment, the first contacts are arranged twisted about a longitudinal direction of the safety fuses relative to the second contacts.

In a further embodiment, at least one of the contacts comprises an inner thread for electrical contacting purposes.

In a further embodiment, the first contacts and/or the second contacts are embodied as blade contacts.

In a further embodiment, at least one of the blade contacts comprises a borehole for electrical contacting purposes.

In a further embodiment, at least one of the blade contacts is embodied with slots.

In a further embodiment, the first contacts each comprise a first slot which is aligned with a first direction, and the second contacts each comprise a second slot which is aligned along the longitudinal direction, oriented at right angles to the first direction.

### BRIEF DESCRIPTION OF THE DRAWINGS

Example embodiments of a fuse arrangement are described in more detail with the aid of the appended figures, in which:

FIGS. 1A to 1D show schematic representations of a first exemplary embodiment of the fuse arrangement,

FIGS. 2A to 2D show schematic representations of a second exemplary embodiment of the fuse arrangement;

FIGS. 3A to 3C show schematic representations of a third exemplary embodiment of the fuse arrangement;

FIGS. 4A to 4D show schematic representations of a fourth exemplary embodiment of the fuse arrangement.

### DETAILED DESCRIPTION

Embodiments disclosed herein provide a fuse arrangement, which may overcome certain problems discussed above regarding conventional fuse arrangement.

In one embodiment, a fuse arrangement comprises a first safety fuse and a second safety fuse, which is arranged adjacent to the first safety fuse and is provided to form an electrical parallel connection with the first safety fuse. Furthermore, the fuse arrangement comprises an end plate, which is mechanically coupled to the first safety fuse and the second safety fuse such that a structural unit is herewith formed.

The first safety fuse and the second safety fuse are permanently connected to the end plate so that neither of the two safety fuses can be disconnected from the assembly of the fuse arrangement without the assistance of a tool. Alternatively, the safety fuses are undetachably connected to the end plate, so that one of the safety fuses is detached from the assembly upon destruction of said safety fuse and/or the end plate. A simple disassembly and thus replacement of only one of the two safety fuses is therefore no longer possible. Since the first safety fuse and the second safety fuse now form a structural unit of two safety fuses connected electrically in parallel with one another, the stricter approval pre-requisites, which no longer allow for assembly and/or disassembly of individual safety fuses, can also no longer be fulfilled. The parallel connection of several safety fuses can use narrower and flatter safety bodies, since the maximum current strength of the individual safety fuses which are electrically connected in parallel is reduced accordingly. The installation space required for the arrangement can therefore be kept correspondingly more compact than would be the case with a single safety fuse having a corresponding maximum current strength of three times more.

The electrical parallel connection of the first safety fuse and the second safety fuse can take place by way of the end plate, which to this end has to be embodied to be conductive. Alternatively however, a non-conductive end plate can also be used, for instance made of plastic, wherein in this case the electrical parallel connection of the first and second safety fuse takes place by way of the electrical connections and/or contacts of the safety fuses.

In one embodiment, the fuse arrangement comprises at least one further safety fuse, which is electrically connected in parallel to the first safety fuse and the second safety fuse and is likewise mechanically coupled to the end plate. With the aid of a correspondingly embodied end plate, depending on the application, three or more safety fuses can also be connected to the end plate without any large structural outlay and thus combined to form a structural unit which is assembled and disassembled together such that a disconnection of an individual safety fuse from the assembly, i.e. from this structural unit, is no longer possible.

In a further embodiment of the fuse arrangement, the safety fuses comprise in each instance a first contact and in each instance a second contact. The first contacts and second contacts are guided out of the safety body of the respective safety fuse and are used to electrically contact the respective safety fuse.

In a further embodiment of the fuse arrangement, the first contacts are arranged twisted about a longitudinal direction of the safety fuses relative to the second contacts. Each first contact may be at 45° or 90° about the longitudinal direction relative to the second contact of the relevant safety fuse. The fuse arrangement can in this way be flexibly adjusted to the most varied of operating conditions.

In a further embodiment of the fuse arrangement, at least one of the contacts comprises an inner thread for electrical contacting purposes. With the aid of the inner thread, which may be embodied as a metric ISO thread, the fuse can also be electrically contacted by means of a corresponding screw connection, for instance of the M10 or M12 type.

In a further embodiment of the fuse arrangement, the first contacts and/or the second contacts are embodied as blade contacts. Blade contacts are also referred to as contact blades and are embodied in a correspondingly compact manner in order to conduct higher currents.

In a further embodiment of the fuse arrangement, at least one of the blade contacts comprises a borehole for electrical contacting purposes.

In a further embodiment of the fuse arrangement, at least one of the blade contacts is embodied with slots. Slotted blade contacts enable a quick and simple fastening and contacting of the fuse arrangement, for instance on a busbar.

In a further embodiment of the fuse arrangement, the first contacts each comprise a first slot, which is aligned with a first direction. The second contacts each comprise a second slot, which is aligned along the longitudinal direction, oriented at right angles to the first direction. By the first slots being aligned in the first direction and the second slots in the second direction, which is oriented at right angles, e.g., perpendicular, to the first direction, a compensatory tolerance is realized, i.e. a possibility of compensating for manufacturing tolerances relating to the dimensions of the individual safety fuses. A higher flexibility in respect of adjustment to different operating conditions of the fuse arrangement is achieved in this way by the varied alignment of the slots.

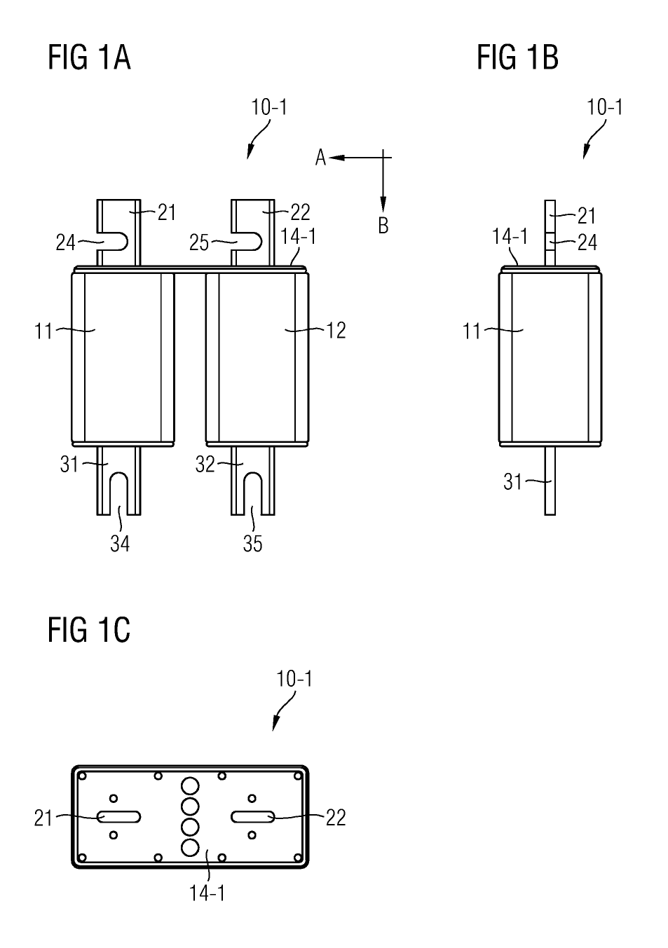

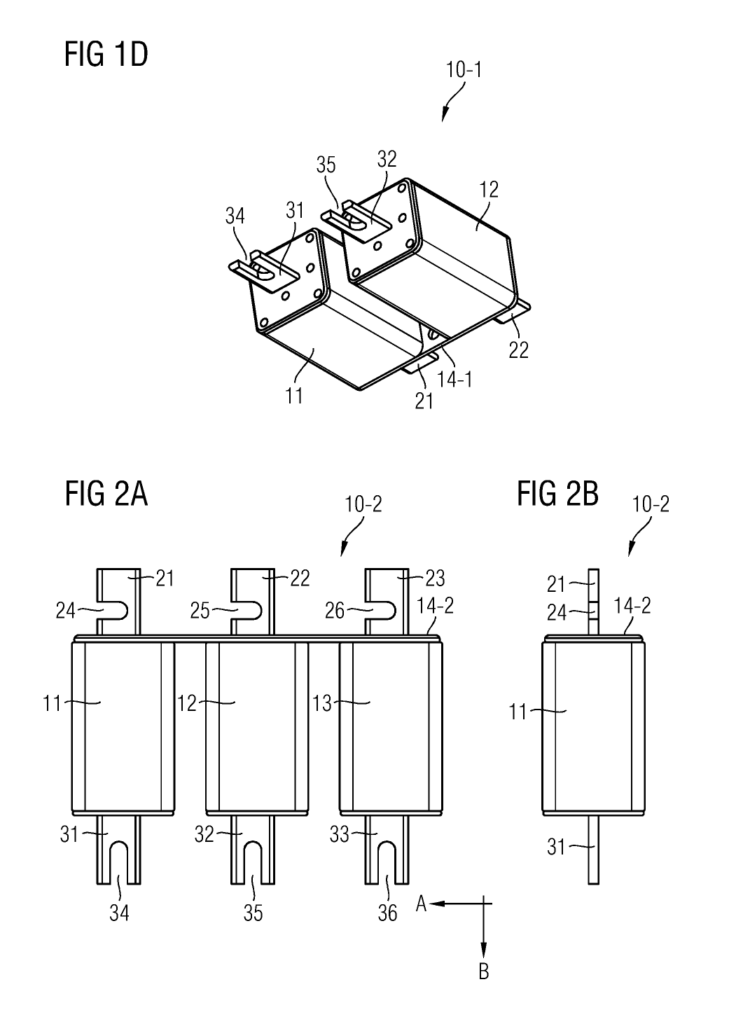

FIGS. 1A to 1D show schematic representations of a first exemplary embodiment of a fuse arrangement 10-1 in several views. A first safety fuse 11 and a second safety fuse 12 are combined to form a structural unit with the aid of an end plate 14-1. The two safety fuses 11 and 12 comprise a square safety body and are mechanically permanently connected to the end plate 14-1. The first safety fuse 11 comprises a first contact 21 and a second contact 31. Similarly, the second safety fuse 12 comprises a first contact 22 and a second contact 32. The first contacts 21 and 22 are passed here through a correspondingly embodied opening in the end plate 14-1. In order to realize a fixed connection of the end plate 14-1 with the first safety fuse 11 and the second safety fuse 12, these can be glued to the end plate 14-1 for instance.

The first contacts 21 and 22 are embodied as slotted blade contacts and to this end comprise in each instance a first slot 24 and/or 25, which is aligned respectively with a first direction A. Similarly, the second contacts 31 and 32 are embodied as slotted blade contacts and each comprise a second slot 34 and/or 35, which is aligned in each instance with a second direction B, which is oriented essentially at right angles to the first direction A. On account of the different, essentially perpendicular alignment of the first slots 24 and 25 relative to the second slots 34 and 35, a compensatory tolerance, i.e. possibility of compensating for manufacturing-specific dimensional tolerances of the individual safety fuses, is enabled. The use of slotted blade contacts 21, 22, 31 and 32 further makes it possible to fasten and contact the fuse arrangement 10-1 rapidly and simply, for instance on a conventional busbar (not shown).

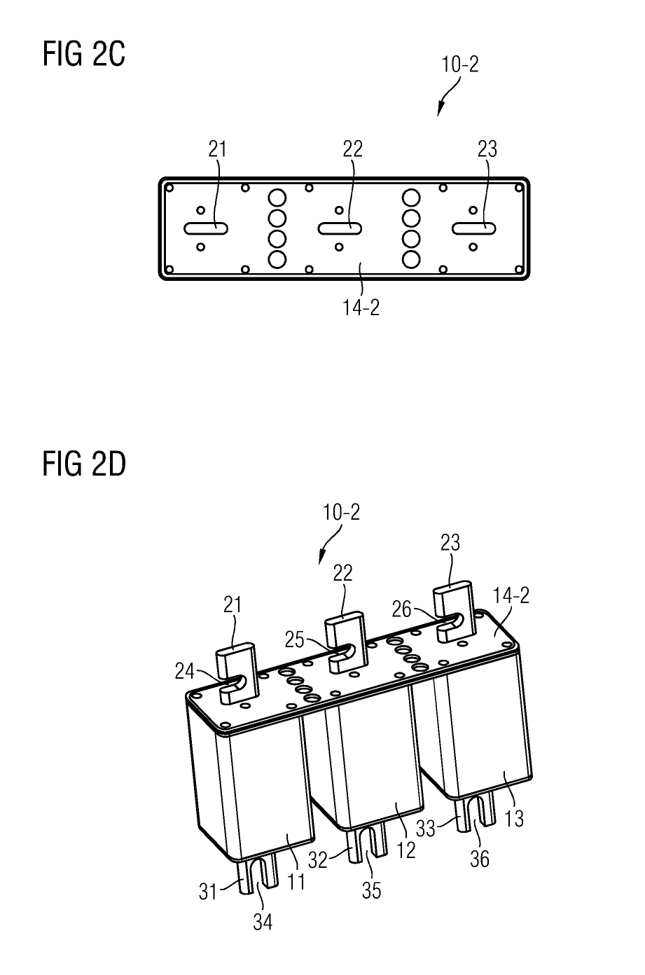

FIGS. 2A to 2D show schematic representations of a second exemplary embodiment of the fuse arrangement 10-2 in several views. Contrary to the first exemplary embodiment shown in Figures 1A to 1D, aside from the first safety fuse 11 and the second safety fuse 12, a further safety fuse 13 is mechanically coupled here to a suitable end plate 14-2, i.e. to the end plate 14-2. The further safety fuse 13 is identical in construction to the first safety fuse 11 and/or the second safety fuse 12 and comprises a first contact 23 with a first slot 26 and a second contact 33 with a second slot 36. The end plate 14-2 corresponds here essentially to the end plate 14-1 shown in the first exemplary embodiment, with the difference that the end plate 14-2 is embodied for the mechanical coupling of three safety fuses 11, 12 and 13 and to this end comprises a further opening, through which the first contact 23 of the further safety fuse 13 is passed.

With this embodiment, three essentially structurally identical safety fuses 11, 12 and 13 are electrically connected in parallel to one another, so that the electric current splits into the three safety fuses 11, 12 and 13. The maximum current strength of this fuse arrangement 10-2 thus corresponds to three times the maximum current strength of the individual, structurally identical safety fuses 11, 12 and 13. The individual safety fuses 11, 12 and 13 can in this way be embodied to be narrower and flatter so that the installation space required for this fuse arrangement 10-2 can be kept correspondingly more compact than would be the case with a single safety fuse having a maximum current strength of correspondingly three times more.

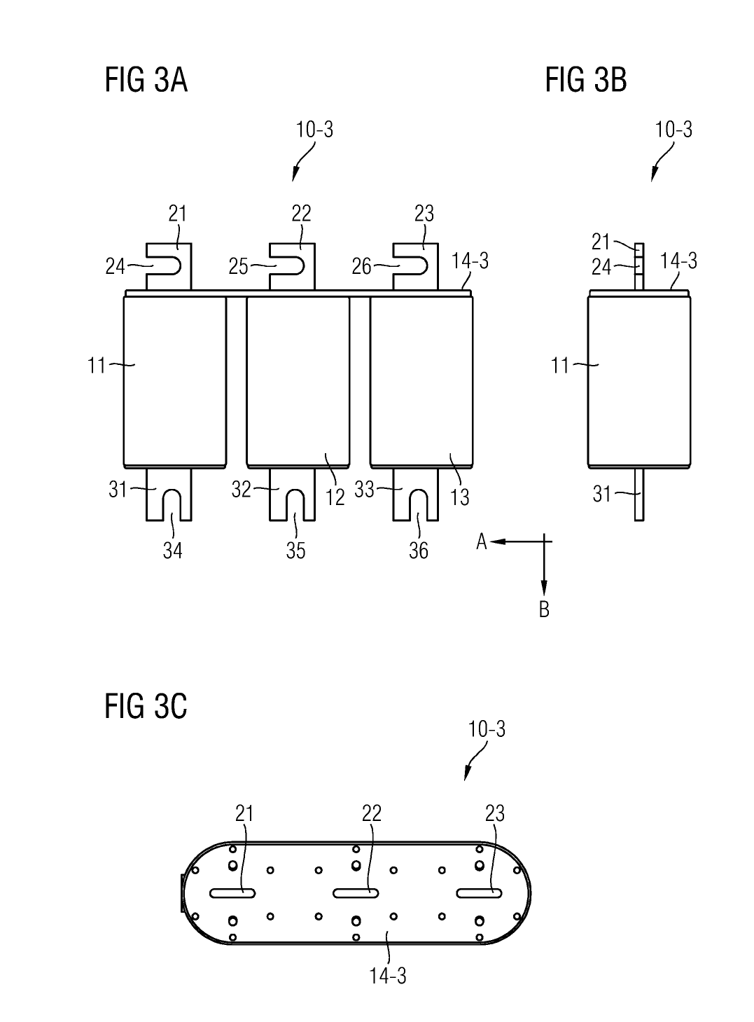

A third exemplary embodiment of the fuse arrangement 10-3 is shown schematically in several views in FIGS. 3A to 3C. Here, aside from the first safety fuse 11 and the second safety fuse 12, a further safety fuse 13 is in turn mechanically coupled to a correspondingly embodied end plate 14-3, such as also already shown in the second exemplary embodiment in FIGS. 2A to 2D. Contrary to this, the safety fuses 11, 12 and 13 nevertheless comprise a cylindrical safety body. The end plate 14-3 assumes this shape and is therefore embodied to be correspondingly rounded in its border areas. This arrangement otherwise corresponds to the fuse arrangement 10-2 shown in FIGS. 2A to 2D.

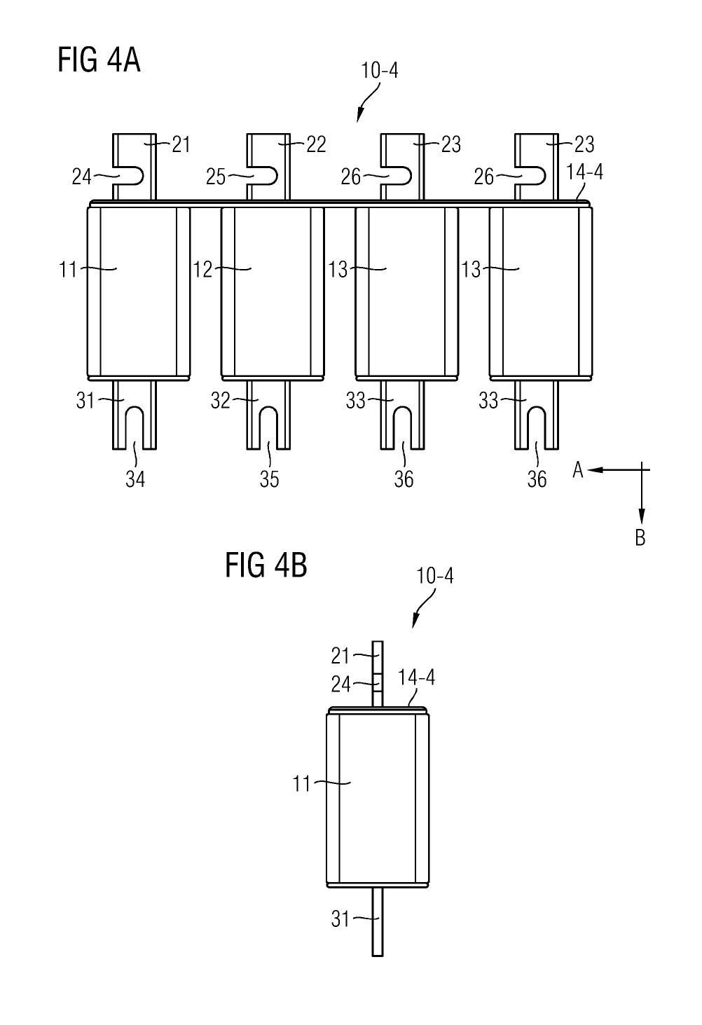

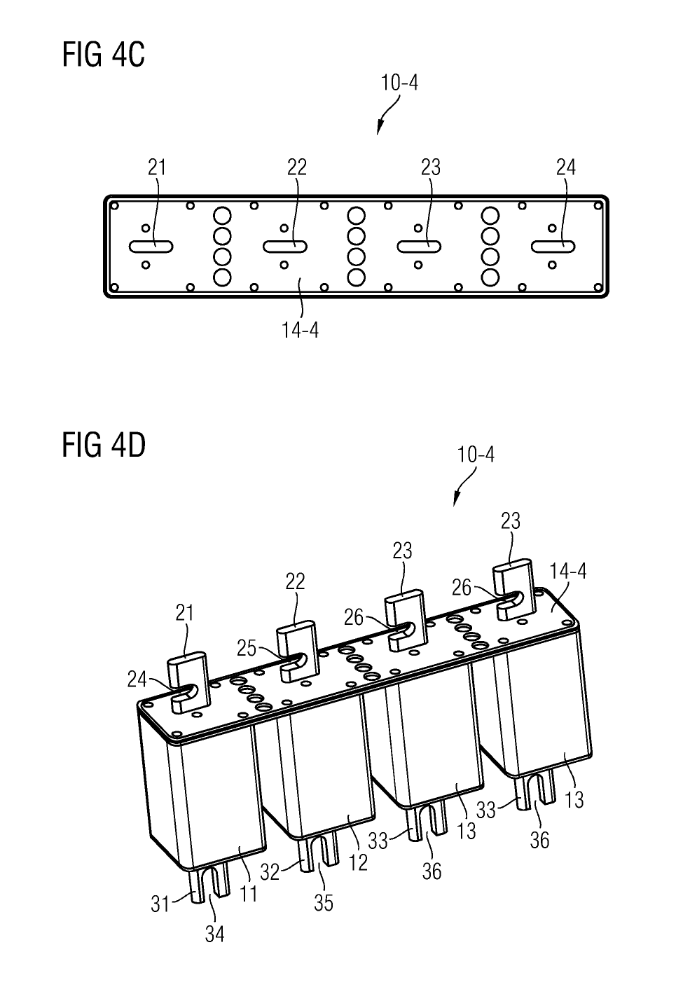

In FIGS. 4A to 4D, a fourth exemplary embodiment of the fuse arrangement 10-4 is shown schematically in several views. Here four square safety fuses—the first safety fuse 11, the second safety fuse 12 and two further safety fuses 13—are combined to form a structural unit by means of a correspondingly embodied end plate 14-4. The current flow is in this way split into four safety fuses. Otherwise this arrangement corresponds to the fuse arrangements 10-1 or 1-2 shown in FIGS. 1A to 1D and 2A to 2D.

### LIST OF REFERENCE CHARACTERS

10 fuse arrangement
11 first safety fuse
12 second safety fuse
13 further safety fuse
14 end plate
21 first contact
22 first contact
23 first contact
24 first slot
25 first slot
26 first slot
31 second contact
32 second contact
33 second contact
34 second slot
35 second slot
36 second slot
A first direction
B longitudinal direction

What is claimed is:

1. A fuse arrangement, comprising:
a first safety fuse,
a second safety fuse arranged adjacent to the first safety fuse, the first and second safety fuses being electrically connected in parallel, and
an end plate mechanically coupled to the first safety fuse and the second safety fuse to form a structural unit.

2. The fuse arrangement of claim 1, comprising at least one further safety fuse electrically connected in parallel to the first safety fuse and the second safety fuse and mechanically coupled to the end plate.

3. The fuse arrangement of claim 1, wherein each safety fuse comprises a first contact and a second contact.

4. The fuse arrangement of claim 3, wherein the first contacts are arranged twisted about a longitudinal direction of the safety fuses relative to the second contacts.

5. The fuse arrangement of claim 3, wherein at least one of the contacts comprises an inner thread for electrical contacting purposes.

6. The fuse arrangement of claim 3, wherein at least one of the first contact and the second contacts are embodied as blade contacts.

7. The fuse arrangement of claim 6, wherein at least one of the blade contacts comprises a borehole for electrical contacting purposes.

8. The fuse arrangement of claim 6, wherein at least one of the blade contacts comprises slots.

9. The fuse arrangement of claim 8, wherein:
each first contact comprises a first slot aligned with a first direction, and each second contact comprises a second slot aligned along a longitudinal direction perpendicular to the first direction.

10. A circuit comprising:
a current source, and
a fuse arrangement electrically coupled to the current source, the fuse arrangement comprising:
a first safety fuse,
a second safety fuse arranged adjacent to the first safety fuse, the first and second safety fuses being electrically connected in parallel, and
an end plate mechanically coupled to the first safety fuse and the second safety fuse to form a structural unit.
